(19) United States
(12) Patent Application Publication
(10) Pub. No.: US 2024/0276147 A1
(43) Pub. Date: Aug. 15, 2024

(54) AUDIO SIGNAL PROCESSING APPARATUS, AUDIO SIGNAL PROCESSING METHOD, AND ELECTRONIC DEVICE

(71) Applicant: SONY GROUP CORPORATION, TOKYO (JP)

(72) Inventor: SHUAI JI, TOKYO (JP)

(21) Appl. No.: 18/568,462

(22) PCT Filed: Feb. 8, 2022
(86) PCT No.: PCT/JP2022/004948

§ 371 Date: Dec. 8, 2023

(30) Foreign Application Priority Data
Jun. 18, 2021 (JP) 2021-101285

(51) Int. Cl. H04R 3/00; H04R 5/027

(52) U.S. Cl. CPC H04R 3/005; H04R 5/027; H04R 2499/11

(57) ABSTRACT

The present technique makes it possible to satisfactorily collect sound coming from a predetermined direction using a non-directional microphone.

An audio signal conversion unit converts an audio signal obtained by collecting sound by the non-directional microphone into a unidirectional audio signal. For example, the audio signal conversion unit is configured with a deep neural network. In this case, for example, the deep neural network is trained to learn to minimize a difference between an acoustic feature amount extracted from an audio signal converted by the deep neural network and an acoustic feature amount extracted from a unidirectional audio signal obtained by collecting sound by a unidirectional microphone.

### TECHNICAL FIELD

The present technique relates to an audio signal processing apparatus, an audio signal processing method, and an electronic device, and more particularly to an audio signal processing apparatus capable of satisfactorily collecting sound coming from a predetermined direction using a non-directional microphone, and the like.

### BACKGROUND ART

As is conventionally known, a smartphone includes a sound collecting function together with an image capturing function. Thus, the smartphone can be used as an image recording/sound recording device when an interviewer conducts an interview with an interviewee. Here, a microphone attached to the smartphone, which is a non-directional microphone, has the disadvantage that when collecting the sound of the interviewer or the interviewee, the microphone also collects surrounding noise at a large level.

For example, Patent Document 1 discloses a technique for controlling the directivity of a microphone unit on the basis of a range occupied by a face of a person in a live-view image. According to the disclosure, as the microphone, two microphones of a sharp directional microphone and a non-directional microphone are used in this case, and changing the individual output signal levels makes the directivity narrowed when the person is far from a digital video camera (DVC) or widened when the person is close to the DVC, thereby reliably emphasizing the voice emitted by the person.

### CITATION LIST

### Patent Document

Patent Document 1: Japanese Patent Application Laid-Open No. 2011-061461

### SUMMARY OF THE INVENTION

### Problems to be Solved by the Invention

An object of the present technique is to make it possible to satisfactorily collect sound coming from a predetermined direction using a non-directional microphone.

### Solutions to Problems

A concept of the present technique lies in
an audio signal processing apparatus including
an audio signal conversion unit that converts an audio signal obtained by collecting sound by a non-directional microphone into a unidirectional audio signal.

In the present technique, the audio signal conversion unit converts an audio signal obtained by collecting sound by the non-directional microphone into a unidirectional audio signal. For example, the audio signal conversion unit may be configured with a deep neural network (DNN). In this case, for example, the deep neural network may be trained to learn to minimize a difference between an acoustic feature amount extracted from an audio signal converted by the deep neural network and an acoustic feature amount extracted from a unidirectional audio signal obtained by collecting sound by a unidirectional microphone.

Here, for example, the acoustic feature amount may be extracted as information of individual layers of a convolutional neural network (CNN). In this case, for example, the convolutional neural network may be trained to learn to be able to distinguish between an audio signal obtained by collecting sound by the non-directional microphone and a unidirectional audio signal obtained by collecting sound by the unidirectional microphone.

As described above, in the present technique, the audio signal processing apparatus includes the audio signal conversion unit that converts an audio signal obtained by collecting sound by the non-directional microphone into a unidirectional audio signal. Therefore, it is possible to satisfactorily collect sound coming from a predetermined direction using a non-directional microphone.

Note that, in the present technique, for example, the non-directional microphone may be a microphone attached to an electronic device including an image capturing function. In this case, for example, the electronic device may be a smartphone. Here, the smartphone may include, as the non-directional microphone, a first microphone provided on a top side and a second microphone provided on a bottom side, and the audio signal conversion unit may convert a mixed signal of an audio signal obtained by collecting sound by the first microphone and an audio signal obtained by collecting sound by the second microphone into a unidirectional audio signal.

In addition, in this case, for example, the audio signal processing apparatus may include, as the audio signal conversion unit, a first audio signal conversion unit that converts an audio signal obtained by collecting sound by the non-directional microphone into a unidirectional audio signal of a front direction, and a second audio signal conversion unit that converts an audio signal obtained by collecting sound by the non-directional microphone into a unidirectional audio signal of a back direction, and the audio signal processing apparatus may further include an audio signal selection unit that selectively outputs a unidirectional audio signal of a front direction obtained by converting by the first audio signal conversion unit or a unidirectional audio signal of a back direction obtained by converting by the second audio signal conversion unit. This can achieve a state in which sound coming from the front direction or sound coming from the back direction is selectively collected.

Here, for example, the audio signal processing apparatus may further include a sound direction recognition unit that recognizes whether sound is coming from the front direction or sound is coming from the back direction, and the audio signal selection unit may output a unidirectional audio signal of a front direction obtained by converting by the first audio signal conversion unit when it is recognized that sound is coming from the front direction, and outputs a unidirectional audio signal of a back direction obtained by converting by the second audio signal conversion unit when it is recognized that sound is coming from the back direction. For example, the sound direction recognition unit may be configured with a convolutional neural network, and may receive, as an input, an audio signal obtained by collecting sound by the non-directional microphone and output a recognition result. In this case, it is possible to save time and effort for selection by the user.

In addition, another concept of the present technique lies in
an audio signal processing method including
a procedure of converting an audio signal obtained by collecting sound by a non-directional microphone into a unidirectional audio signal.

In addition, still another concept of the present technique lies in
an electronic device including an image capturing function, including
a non-directional microphone, and
an audio signal conversion unit that converts an audio signal obtained by collecting sound by the non-directional microphone into a unidirectional audio signal.

### BRIEF DESCRIPTION OF DRAWINGS

FIG. 1 is a block diagram illustrating a configuration example of an audio signal processing apparatus according to an embodiment.

FIG. 2 is a diagram illustrating a usage example of a smartphone including the audio signal processing apparatus.

FIG. 3 is a diagram illustrating an example of a learning structure of a convolutional neural network used as a sound direction recognition unit.

FIG. 4 is a diagram illustrating an example of a measurement environment in which a plurality of audio signals in a case of sound coming from a front side and a back side is obtained as learning data.

FIG. 5 is a diagram illustrating an example of a learning structure of a deep neural network used as a front unidirectional audio signal conversion unit.

FIG. 6 is a diagram illustrating an example of a learning structure of a front acoustic feature extraction model (CNN model).

FIG. 7 is a diagram illustrating an example of a measurement environment in which a plurality of audio signals in a case of sound coming from the front side of the smartphone is obtained as learning data.

FIG. 8 is a diagram illustrating an example of a measurement environment in which a plurality of audio signals in a case of sound coming from the front side is obtained as learning data.

FIG. 9 is a diagram illustrating an example of a learning structure of a deep neural network used as a back unidirectional audio signal conversion unit.

FIG. 10 is a diagram illustrating an example of a learning structure of a back acoustic feature extraction model (CNN model).

FIG. 11 is a diagram illustrating an example of a measurement environment in which a plurality of audio signals in a case of sound coming from the back side of the smartphone is obtained as learning data.

FIG. 12 is a diagram illustrating an example of a measurement environment in which a plurality of audio signals in a case of sound coming from the back side is obtained as learning data.

### MODE FOR CARRYING OUT THE INVENTION

Hereinafter, a mode for carrying out the invention (hereinafter referred to as an “embodiment”) will be described. Note that the description will be made in the following order.
1. Embodiment
2. Modification

### 1. Embodiment

### [Configuration of Audio Signal Processing Apparatus]

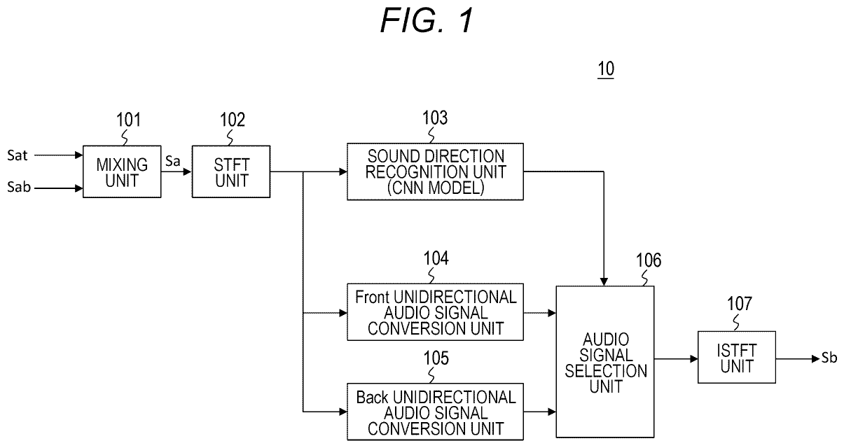

FIG. 1 illustrates a configuration example of an audio signal processing apparatus 10 according to an embodiment. The audio signal processing apparatus 10 is included in a smartphone. The smartphone constitutes an electronic device including an image capturing function.

The audio signal processing apparatus 10 includes a mixing unit 101, a short-time Fourier transform (STFT) unit 102, a sound direction recognition unit 103, a front unidirectional audio signal conversion unit 104, a back unidirectional audio signal conversion unit 105, an audio signal selection unit 106, and an inverse short-time Fourier transform (ISTFT) unit 107.

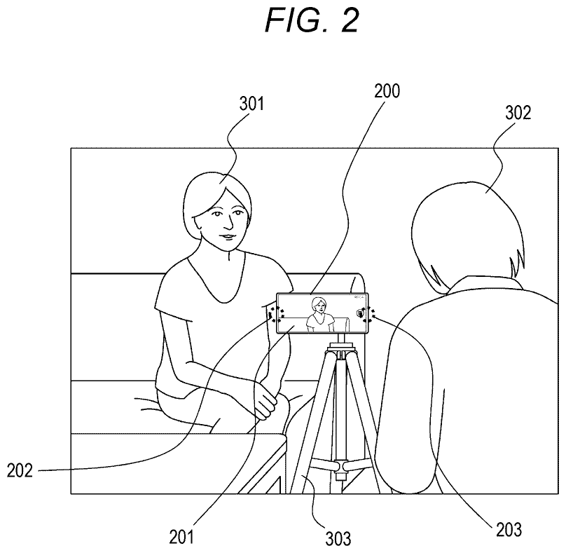

FIG. 2 illustrates a usage example of a smartphone 200 including the audio signal processing apparatus 10. In this example, the smartphone 200 is used as an image recording/sound recording device when an interviewer 302 conducts an interview with an interviewee 301. The smartphone 200 is fixedly positioned horizontally by a tripod 303 between the interviewer 303 and the interviewee 301. In this case, the interviewee 301 is on the front side of the smartphone 200, and the interviewer 302 is on the back side of the smartphone 200.

In this case, the smartphone 200 captures and records the interviewee 301. In this case, a captured image is displayed on a display 201 of the smartphone 200, and the interviewer 302 can check the captured image. In addition, as indicated by broken line circles, the smartphone 200 is provided with a non-directional microphone 202 on the top side thereof and is also provided with a non-directional microphone 203 on the bottom side thereof. In the smartphone 200, audio signals obtained by collecting sound by the non-directional microphones 202 and 203 are processed by the audio signal processing apparatus 10 to be recorded.

Returning to FIG. 1, the mixing unit 101 mixes (adds) an audio signal Sat obtained by collecting sound by the non-directional microphone 202 on the top side and an audio signal Sab obtained by collecting sound by the non-directional microphone 203 on the bottom side to output a mixed audio signal Sa.

The STFT unit 102 performs short-time Fourier transform on the audio signal Sa output from the mixing unit 101, converting the audio signal in the time domain into an audio signal in the frequency domain.

The sound direction recognition unit 103 recognizes, on the basis of the output signal (the audio signal in the frequency domain) by the STFT unit 102, the direction of the sound coming, that is, here, whether the sound comes from the front side (the interviewee 301 side) or the back side (the interviewer 302 side). The sound direction recognition unit 103 is configured with, for example, a convolutional neural network (CNN).

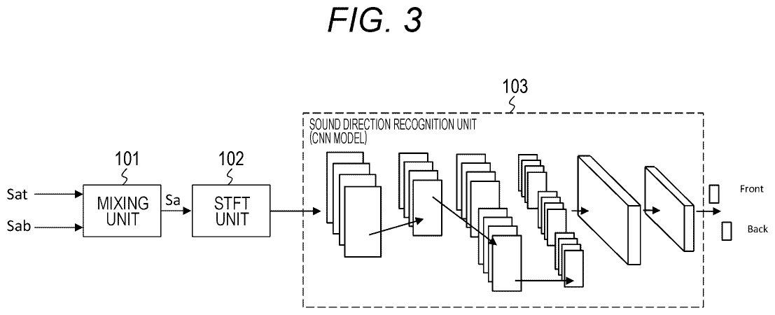

FIG. 3 illustrates an example of a learning structure of a convolutional neural network used as the sound direction recognition unit 103. In this case, the learning is performed using, as learning data, a plurality of audio signals Sat and Sab in a case of sound coming from the front side and a plurality of audio signals Sat and Sab in a case of sound coming from the back side. Note that as described above, the audio signal Sat is the audio signal obtained by collecting sound by the non-directional microphone 202 on the top side of the smartphone 200, and the audio signal Sab is the audio signal obtained by collecting sound by the non-directional microphone 203 on the bottom side of the smartphone 200.

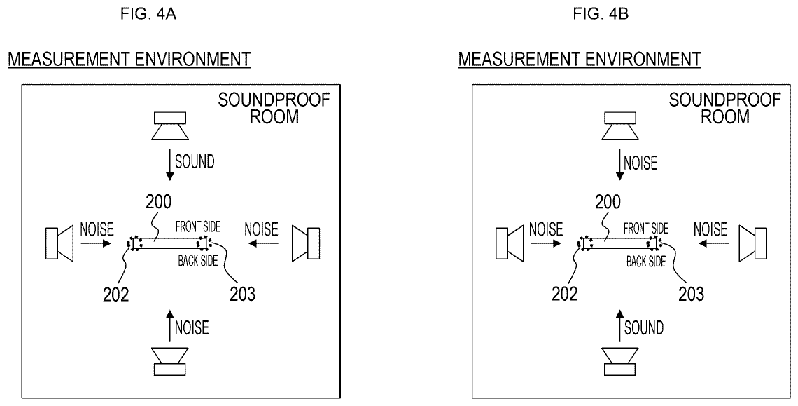

FIG. 4 (a) illustrates an example of a measurement environment in which the plurality of audio signals Sat and Sab in a case of sound coming from the front side is obtained as the learning data. In this case, in a soundproof room, the smartphone 200 is fixedly positioned horizontally, and sound comes from the front side thereof and noise comes from other directions (that are three directions of the back side, the left side, and the right side in the example illustrated in the diagram, but the present invention is not limited thereto). By changing the type of sound, the level of sound, the type of noise, the level of noise, the direction from which the noise comes, and the like with this arrangement, a plurality of sets of the audio signals Sat and Sab can be obtained.

FIG. 4 (b) illustrates an example of a measurement environment in which the plurality of audio signals Sat and Sab in a case of sound coming from the back side is obtained as the learning data. In this case, in a soundproof room, the smartphone 200 is fixedly positioned horizontally, and sound comes from the back side thereof and noise comes from other directions (that are three directions of the front side, the left side, and the right side in the example illustrated in the diagram, but the present invention is not limited thereto). By changing the type of sound, the level of sound, the type of noise, the level of noise, the direction from which the noise comes, and the like with this arrangement, a plurality of sets of the audio signals Sat and Sab can be obtained.

In the learning structure illustrated in FIG. 3, the audio signals Sat and Sab are mixed (added) by the mixing unit 101, and the mixed audio signal Sa is converted from the audio signal in the time domain into the audio signal in the frequency domain by the STFT unit 102 and then input to the convolutional neural network used as the sound direction recognition unit 103.

In this case, the convolutional neural network used as the sound direction recognition unit 103 is trained to learn, using a plurality of pieces of the learning data as described above, to recognize that the direction of the sound coming is from the front side when each of the plurality of audio signals Sat and Sab in a case of sound coming from the front side is input, and that the direction of the sound coming is from the back when each of the plurality of audio signals Sat and Sab in a case of sound coming from the back side is input.

Returning to FIG. 1, the front unidirectional audio signal conversion unit 104 converts the output signal (the audio signal in the frequency domain) by the STFT unit 102 into a unidirectional audio signal of the front direction. The front unidirectional audio signal conversion unit 104 constitutes a first audio signal conversion unit. The front unidirectional audio signal conversion unit 104 is configured with, for example, a deep neural network (DNN) such as a convolutional neural network (CNN).

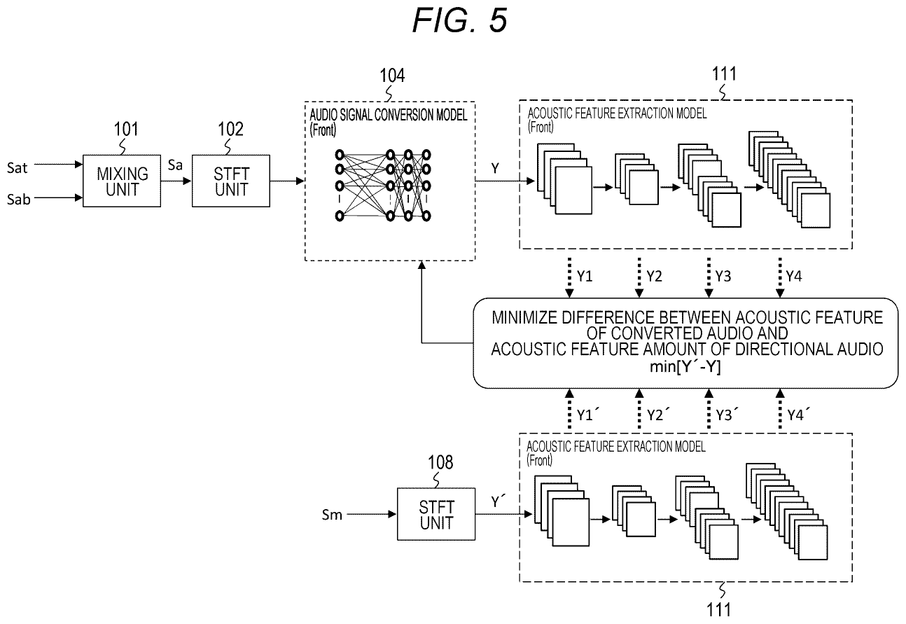

FIG. 5 illustrates an example of a learning structure of a deep neural network used as the front unidirectional audio signal conversion unit 104. In this case, a front acoustic feature extraction model (CNN model) 111 is used, and is trained to learn to minimize a difference between an acoustic feature amount extracted from the audio signal converted by this deep neural network and an acoustic feature amount extracted from the unidirectional audio signal obtained by collecting sound by the unidirectional microphone facing the front direction.

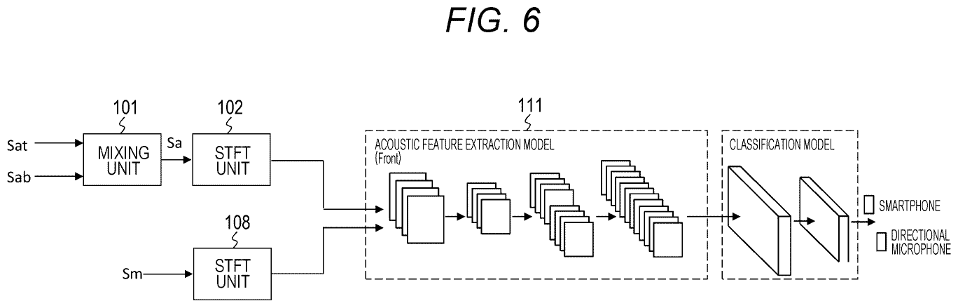

FIG. 6 illustrates an example of a learning structure of the front acoustic feature extraction model (CNN model) 111. In this case, the learning is performed using, as learning data, the plurality of audio signals Sat and Sab in a case of sound coming from the front side and a plurality of audio signals Sm in a case of sound coming from the front side.

Note that as described above, the audio signal Sat is the audio signal obtained by collecting sound by the non-directional microphone 202 on the top side of the smartphone 200, and the audio signal Sab is the audio signal obtained by collecting sound by the non-directional microphone 203 on the bottom side of the smartphone 200. In addition, the audio signal Sm is an audio signal obtained by collecting sound by the unidirectional microphone facing, so as to collect the sound coming from the front side of the smartphone 200, the direction from which the sound comes.

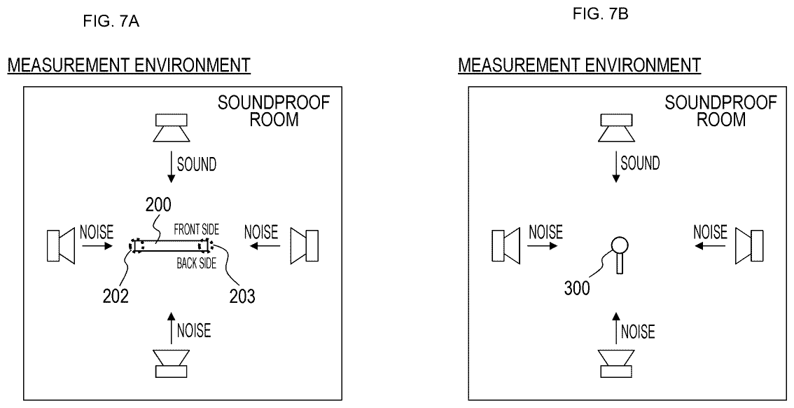

FIG. 7 (a) illustrates an example of a measurement environment in which the plurality of audio signals Sat and Sab in a case of sound coming from the front side of the smartphone 200 is obtained as the learning data. In this case, in a soundproof room, the smartphone 200 is fixedly positioned horizontally, and sound comes from the front side thereof and noise comes from other directions (that are three directions of the back side, the left side, and the right side in the example illustrated in the diagram, but the present invention is not limited thereto). By changing the type of sound, the level of sound, the type of noise, the level of noise, the direction from which the noise comes, and the like with this arrangement, a plurality of sets of the audio signals Sat and Sab can be obtained.

FIG. 7 (b) illustrates an example of a measurement environment in which the plurality of audio signals Sm in a case of sound coming from the front side is obtained as the learning data. In this case, in a soundproof room, with a state in which sound and noise are generated similarly to FIG. 7 (a), the unidirectional microphone 300 is fixedly positioned facing the direction from which sound comes. By changing the type of sound, the level of sound, the type of noise, the level of noise, the direction from which the noise comes, and the like with this arrangement, a plurality of the audio signals Sm can be obtained.

In the learning structure illustrated in FIG. 6, the audio signals Sat and Sab are mixed (added) by the mixing unit 101, and the mixed audio signal Sa is converted from the audio signal in the time domain into the audio signal in the frequency domain by the STFT unit 102 and then input to the front acoustic feature extraction model (CNN model) 111. In addition, in the learning structure illustrated in FIG. 6, the audio signal Sm is converted from the audio signal in the time domain into the audio signal in the frequency domain by a STFT unit 108 and then input to the front acoustic feature extraction model (CNN model) 111.

In this case, the front acoustic feature extraction model (CNN model) 111 is trained to learn, using a plurality of pieces of the learning data as described above, to cause a classification model, which performs classification on the basis of the output of the front acoustic feature extraction model (CNN model) 111, to recognize the audio signals, when each of the plurality of audio signals Sat and Sab is input, as the audio signals by the smartphone 200, that is, the audio signals obtained by collecting sound by the non-directional microphones 202 and 203 attached to the smartphone 200, and to cause the classification model, which performs classification on the basis of the output of the front acoustic feature extraction model (CNN model) 111, to recognize the audio signals, when each of the plurality of audio signals Sm is input, as the audio signals obtained by collecting sound by the unidirectional microphone 300.

In the course of this learning, the number of layers, the number of parameters, the output size, and the like in the front acoustic feature extraction model (CNN model) 111 are optimized. In the example illustrated in the diagram, the number of layers is optimized to four layers. For the front acoustic feature extraction model (CNN model) 111 that is trained to learn as described above, for example, in a case where the audio signal obtained by collecting sound by the unidirectional microphone 300 is input thereto, the information of individual layers is in a state in which an acoustic feature of the audio signal is satisfactorily extracted.

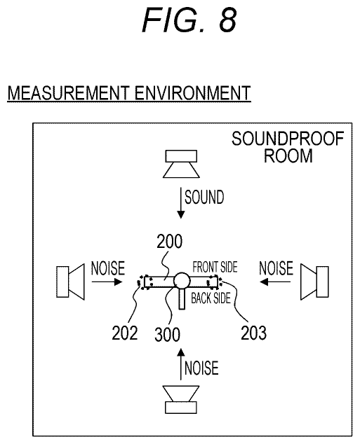

Returning to FIG. 5, in a case of this learning structure, learning is performed using, as learning data, the plurality of audio signals Sat, Sab, and Sm in a case of sound coming from the front side. FIG. 8 illustrates an example of a measurement environment in which the plurality of audio signals Sat, Sab and Sm in a case of sound coming from the front side is obtained as the learning data.

In this case, in a soundproof room, the smartphone 200 is fixedly positioned horizontally, and sound comes from the front side thereof and noise comes from other directions (that are three directions of the back side, the left side, and the right side in the example illustrated in the diagram, but the present invention is not limited thereto). In addition to the smartphone 200, the unidirectional microphone 300 is also fixedly positioned facing the direction from which sound comes. By changing the type of sound, the level of sound, the type of noise, the level of noise, the direction from which the noise comes, and the like with this arrangement, a plurality of sets of the audio signals Sat, Sab and Sm can be obtained.

In the learning structure illustrated in FIG. 5, the audio signals Sat and Sab are mixed (added) by the mixing unit 101, and the mixed audio signal Sa is converted from the audio signal in the time domain into the audio signal in the frequency domain by the STFT unit 102 and then input to the deep neural network used as the front unidirectional audio signal conversion unit 104. Then, the output signal by the deep neural network is input to one of the front acoustic feature extraction models (CNN model) 111. In addition, the audio signal Sm obtained by collecting sound by the unidirectional microphone 300 is converted from the audio signal in the time domain into the audio signal in the frequency domain by the STFT unit 108 and then input to the other front acoustic feature extraction model (CNN model) 111.

In this case, the deep neural network used as the front unidirectional audio signal conversion unit 104 is trained to learn to minimize differences between acoustic feature amounts (information of individual layers) Y1 to Y4 extracted by the one front acoustic feature extraction model 111 from an audio signal Y converted by the deep neural network and acoustic feature amounts (information of individual layers) Y1′ to Y4′ extracted by the other front acoustic feature extraction model 111 from an audio signal Y′ obtained by collecting sound by the unidirectional microphone 300, that is, to make the differences min [Y′−Y].

The learning as described above enables the deep neural network used as the front unidirectional audio signal conversion unit 104 to convert the audio signals obtained by collecting sound by the non-directional microphones 202 and 203 of the smartphone 200 into the unidirectional audio signal Y of the front direction that is similar to the audio signal Y′ obtained by collecting sound by the unidirectional microphone 300.

Returning to FIG. 1, the back unidirectional audio signal conversion unit 105 converts the output signal (the audio signal in the frequency domain) by the STFT unit 102 into a unidirectional audio signal of the back direction. The back unidirectional audio signal conversion unit 105 constitutes a second audio signal conversion unit. Similarly to the above-described front unidirectional audio signal conversion unit 104, the back unidirectional audio signal conversion unit 105 is configured with, for example, a deep neural network (DNN) such as a convolutional neural network (CNN).

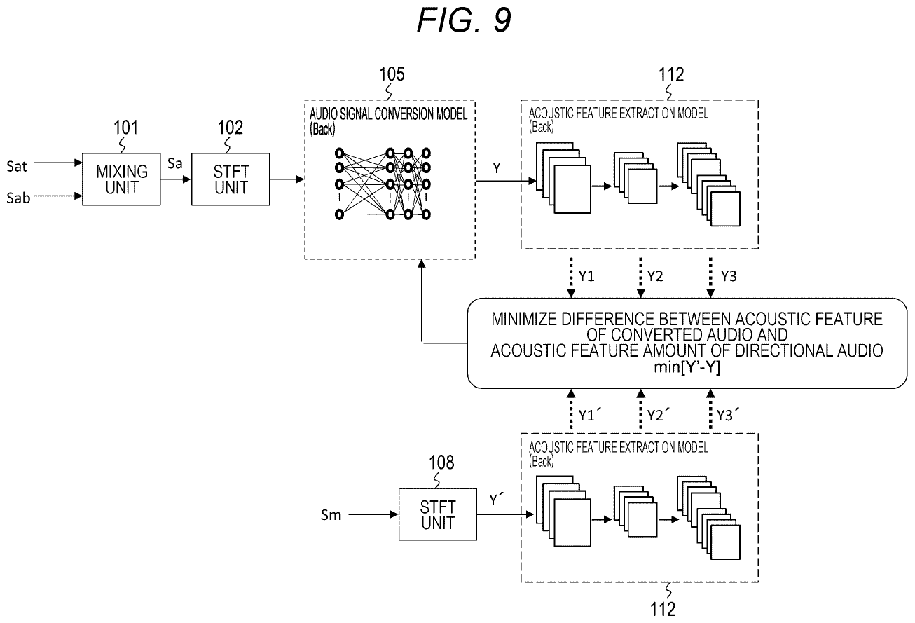

FIG. 9 illustrates an example of a learning structure of a deep neural network used as the back unidirectional audio signal conversion unit 105. In this case, a back acoustic feature extraction model (CNN model) 112 is used, and is trained to learn to minimize a difference between an acoustic feature amount extracted from the audio signal converted by this deep neural network and an acoustic feature amount extracted from the unidirectional audio signal obtained by collecting sound by the unidirectional microphone facing the back direction.

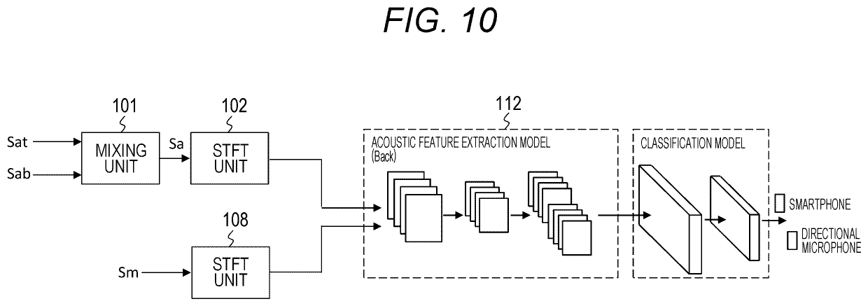

FIG. 10 illustrates an example of a learning structure of the back acoustic feature extraction model (CNN model) 112. In this case, the learning is performed using, as learning data, the plurality of audio signals Sat and Sab in a case of sound coming from the back side and a plurality of audio signals Sm in a case of sound coming from the back side.

Note that as described above, the audio signal Sat is the audio signal obtained by collecting sound by the non-directional microphone 202 on the top side of the smartphone 200, and the audio signal Sab is the audio signal obtained by collecting sound by the non-directional microphone 203 on the bottom side of the smartphone 200. In addition, the audio signal Sm is an audio signal obtained by collecting sound by the unidirectional microphone facing, so as to collect the sound coming from the back side of the smartphone 200, the direction from which the sound comes.

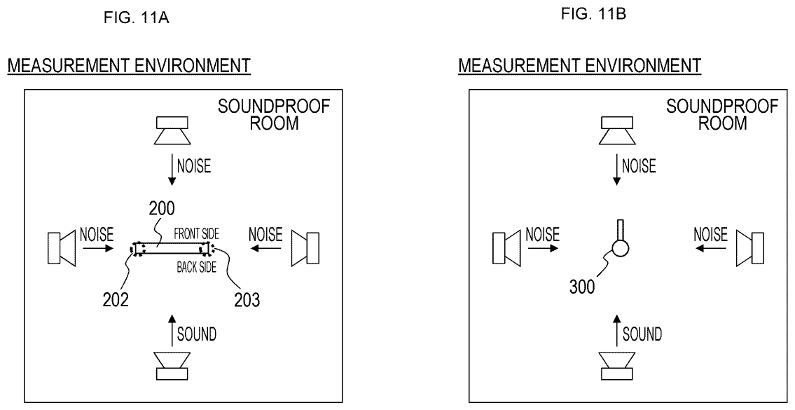

FIG. 11 (a) illustrates an example of a measurement environment in which the plurality of audio signals Sat and Sab in a case of sound coming from the back side of the smartphone 200 is obtained as the learning data. In this case, in a soundproof room, the smartphone 200 is fixedly positioned horizontally, and sound comes from the back side thereof and noise comes from other directions (that are three directions of the front side, the left side, and the right side in the example illustrated in the diagram, but the present invention is not limited thereto). By changing the type of sound, the level of sound, the type of noise, the level of noise, the direction from which the noise comes, and the like with this arrangement, a plurality of sets of the audio signals Sat and Sab can be obtained.

FIG. 11 (b) illustrates an example of a measurement environment in which the plurality of audio signals Sm in a case of sound coming from the back side of the smartphone 200 is obtained as the learning data. In this case, in a soundproof room, with a state in which sound and noise are generated similarly to FIG. 11 (a), the unidirectional microphone 300 is fixedly positioned facing the direction from which sound comes. By changing the type of sound, the level of sound, the type of noise, the level of noise, the direction from which the noise comes, and the like with this arrangement, a plurality of the audio signals Sm can be obtained.

In the learning structure illustrated in FIG. 10, the audio signals Sat and Sab are mixed (added) by the mixing unit 101, and the mixed audio signal Sa is converted from the audio signal in the time domain into the audio signal in the frequency domain by the STFT unit 102 and then input to the back acoustic feature extraction model (CNN model) 112. In addition, in the learning structure illustrated in FIG. 10, the audio signal Sm is converted from the audio signal in the time domain into the audio signal in the frequency domain by the STFT unit 108 and then input to the back acoustic feature extraction model (CNN model) 112.

In this case, the back acoustic feature extraction model (CNN model) 112 is trained to learn, using a plurality of pieces of the learning data as described above, to cause a classification model, which performs classification on the basis of the output of the back acoustic feature extraction model (CNN model) 112, to recognize the audio signals, when each of the plurality of audio signals Sat and Sab is input, as the audio signals by the smartphone 200, that is, the audio signals obtained by collecting sound by the non-directional microphones 202 and 203 attached to the smartphone 200, and to cause the classification model, which performs classification on the basis of the output of the back acoustic feature extraction model (CNN model) 112, to recognize the audio signals, when each of the plurality of audio signals Sm is input, as the audio signals obtained by collecting sound by the unidirectional microphone 300.

In the course of this learning, the number of layers, the number of parameters, the output size, and the like in the back acoustic feature extraction model (CNN model) 112 are optimized. In the example illustrated in the diagram, the number of layers is optimized to three layers. For the back acoustic feature extraction model (CNN model) 112 that is trained to learn as described above, for example, in a case where the audio signal obtained by collecting sound by the unidirectional microphone 300 is input thereto, the information of individual layers is in a state in which an acoustic feature of the audio signal is satisfactorily extracted.

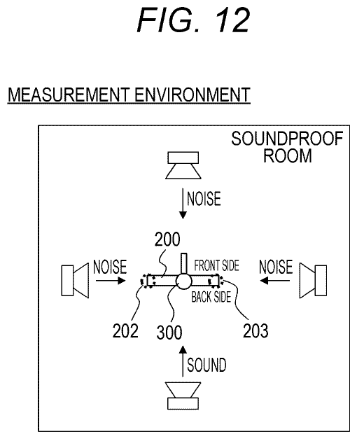

Returning to FIG. 9, in the case of this learning structure, learning is performed using, as learning data, the plurality of audio signals Sat, Sab, and Sm in a case of sound coming from the back side. FIG. 12 illustrates an example of a measurement environment in which the plurality of audio signals Sat, Sab, and Sm in a case of sound coming from the back side is obtained as the learning data.

In this case, in a soundproof room, the smartphone 200 is fixedly positioned horizontally, and sound comes from the back side thereof and noise comes from other directions (that are three directions of the front side, the left side, and the right side in the example illustrated in the diagram, but the present invention is not limited thereto). In addition to the smartphone 200, the unidirectional microphone 300 is also fixedly positioned facing the direction from which sound comes. By changing the type of sound, the level of sound, the type of noise, the level of noise, the direction from which the noise comes, and the like with this arrangement, a plurality of sets of the audio signals Sat, Sab and Sm can be obtained.

In the learning structure illustrated in FIG. 9, the audio signals Sat and Sab are mixed (added) by the mixing unit 101, and the mixed audio signal Sa is converted from the audio signal in the time domain into the audio signal in the frequency domain by the STFT unit 102 and then input to the deep neural network used as the back unidirectional audio signal conversion unit 105. Then, the output signal of the deep neural network is input to one of the back acoustic feature extraction models (CNN model) 112. In addition, the audio signal Sm obtained by collecting sound by the unidirectional microphone 300 is converted from the audio signal in the time domain into the audio signal in the frequency domain by the STFT unit 108 and then input to the other back acoustic feature extraction model (CNN model) 112.

In this case, the deep neural network used as the back unidirectional audio signal conversion unit 105 is trained to learn to minimize differences between acoustic feature amounts (information of individual layers) Y1 to Y3 extracted by the one back acoustic feature extraction model 112 from an audio signal Y converted by the deep neural network and acoustic feature amounts (information of individual layers) Y1′ to Y3′ extracted by the other back acoustic feature extraction model 112 from an audio signal Y′ obtained by collecting sound by the unidirectional microphone 300, that is, to make the differences min [Y′−Y].

The learning as described above enables the deep neural network used as the back unidirectional audio signal conversion unit 105 to convert the audio signals obtained by collecting sound by the non-directional microphones 202 and 203 of the smartphone 200 into the unidirectional audio signal Y of the back direction that is similar to the audio signal Y′ obtained by collecting sound by the unidirectional microphone 300.

Returning to FIG. 1, on the basis of the recognition result by the sound direction recognition unit 103, the audio signal selection unit 106, to which the unidirectional audio signal of the front direction obtained by converting by the front unidirectional audio signal conversion unit 104 and the unidirectional audio signal of the back direction obtained by converting by the back unidirectional audio signal conversion unit 105 are input, selectively outputs either of them.

In this case, when the sound direction recognition unit 103 recognizes that the sound is coming from the front direction, the audio signal selection unit 106 outputs the unidirectional audio signal of the front direction. On the other hand, when the sound direction recognition unit 103 recognizes that the sound is coming from the back direction, the audio signal selection unit 106 outputs the unidirectional audio signal of the back direction.

Note that, the audio signal selection unit 106, which selects the audio signal to be output on the basis of the recognition result by the sound direction recognition unit 103 in this embodiment, may be configured to select the audio signal to be output on the basis of a user operation, for example, an operation by the interviewer 302. In this case, the sound direction recognition unit 103 is unnecessary.

The ISTFT unit 107 performs inverse short-time Fourier transform on the audio signal output from the audio signal selection unit 106, converting the audio signal in the frequency domain into the audio signal in the time domain. Accordingly, the output audio signal Sb of the audio signal processing apparatus 10 can be obtained.

Operation of the audio signal processing apparatus 10 illustrated in FIG. 1 will be briefly described. The audio signal Sat obtained by collecting sound by the non-directional microphone 202 on the top side of the smartphone 200, and the audio signal Sab obtained by collecting sound by the non-directional microphone 203 on the bottom side of the smartphone 200 are supplied to the mixing unit 101 to be mixed (added). Then, the mixed audio signal Sa output from the mixing unit 101 is supplied to the STFT unit 102, and subjected to short-time Fourier transform to be converted from the audio signal in the time domain into the audio signal in the frequency domain.

The output signal (the audio signal in the frequency domain) by the STFT unit 102 is supplied to the sound direction recognition unit 103. The sound direction recognition unit 103 recognizes, on the basis of the output signal by the STFT unit 102, the direction of the sound coming, that is, here, whether the sound comes from the front side or the back side.

In addition, the output signal (the audio signal in the frequency domain) by the STFT unit 102 is supplied to the front unidirectional audio signal conversion unit 104. The front unidirectional audio signal conversion unit 104 converts the output signal by the STFT unit 102 into the unidirectional audio signal of the front direction (the audio signal similar to the audio signal obtained by collecting sound by the unidirectional microphone facing the front direction).

In addition, the output signal (the audio signal in the frequency domain) by the STFT unit 102 is supplied to the back unidirectional audio signal conversion unit 105. The back unidirectional audio signal conversion unit 105 converts the output signal by the STFT unit 102 into the unidirectional audio signal of the back direction (the audio signal similar to the audio signal obtained by collecting sound by the unidirectional microphone facing the back direction).

The unidirectional audio signal of the front direction obtained by converting by the front unidirectional audio signal conversion unit 104 and the unidirectional audio signal of the back direction obtained by converting by the back unidirectional audio signal conversion unit 105 are supplied to the audio signal selection unit 106. The audio signal selection unit 106 selectively outputs, on the basis of the recognition result by the sound direction recognition unit 103, the unidirectional audio signal of the front direction or the unidirectional audio signal of the back direction.

That is, when the sound direction recognition unit 103 recognizes that the sound is coming from the front direction, the unidirectional audio signal of the front direction is output. On the other hand, when the sound direction recognition unit 103 recognizes that the sound is coming from the back direction, the unidirectional audio signal of the back direction is output.

The audio signal (the audio signal in the frequency domain) output from the audio signal selection unit 106 is supplied to the ISTFT unit 107. The ISTFT unit 107 performs inverse short-time Fourier transform on the audio signal output from the audio signal selection unit 106, converting the audio signal in the frequency domain into the audio signal in the time domain. Accordingly, the output audio signal Sb of the audio signal processing apparatus 10 can be obtained. Note that when the interviewer 302 conducts an interview with the interviewee 301 using the smartphone 200 (see FIG. 2), the output audio signal Sb is recorded.

As described above, the audio signal processing apparatus 10 illustrated in FIG. 1, which includes the front unidirectional audio signal conversion unit 104 and the back unidirectional audio signal conversion unit 105, can convert the audio signals obtained by collecting sound by the non-directional microphones 202 and 203 of the smartphone 200 into the audio signal similar to the audio signal obtained by collecting sound by the unidirectional microphone facing the front direction or the back direction. Therefore, it is possible to satisfactorily collect sound coming from the front direction or the back direction using the non-directional microphones 202 and 203. This makes it possible to clearly record sound of questions or responses from the interviewer 302 or the interviewee 301 when the interviewer 302 conducts an interview with the interviewee 301 using the smartphone 200.

In addition, in the audio signal processing apparatus 10 illustrated in FIG. 1, the front unidirectional audio signal conversion unit 104 and the back unidirectional audio signal conversion unit 105 are configured with a deep neural network, for example, a convolutional neural network. This makes it possible to satisfactorily convert the audio signals obtained by collecting sound by the non-directional microphones 202 and 203 of the smartphone 200 into the audio signal similar to the audio signal obtained by collecting sound by the unidirectional microphone facing the front direction or the back direction.

In addition, in the audio signal processing apparatus 10 illustrated in FIG. 1, the deep neural network with which the front unidirectional audio signal conversion unit 104 and the back unidirectional audio signal conversion unit 105 are configured is trained to learn to minimize a difference between the acoustic feature amount extracted from the audio signal converted by the deep neural network and the acoustic feature amount extracted from the unidirectional audio signal obtained by collecting sound by the unidirectional microphone. This makes it possible to satisfactorily convert the audio signals obtained by collecting sound by the non-directional microphones 202 and 203 of the smartphone 200 into the audio signal similar to the audio signal obtained by collecting sound by the unidirectional microphone facing the front direction or the back direction.

In addition, in the audio signal processing apparatus 10 illustrated in FIG. 1, when the deep neural network with which the front unidirectional audio signal conversion unit 104 and the back unidirectional audio signal conversion unit 105 are configured is trained to learn to minimize a difference between the acoustic feature amount extracted from the audio signal converted by the deep neural network and the acoustic feature amount extracted from the unidirectional audio signal obtained by collecting sound by the unidirectional microphone, the acoustic feature amount may be extracted as information of individual layers of the convolutional neural network. This makes it possible to appropriately and effectively extract the acoustic feature amount.

In addition, in the audio signal processing apparatus 10 illustrated in FIG. 1, the audio signal selection unit 106 selectively outputs the unidirectional audio signal of the front direction obtained by converting by the front unidirectional audio signal conversion unit 104 or the unidirectional audio signal of the back direction obtained by converting by the back unidirectional audio signal conversion unit 105. This can achieve a state in which sound coming from the front direction or sound coming from the back direction is selectively collected.

In addition, in the audio signal processing apparatus 10 illustrated in FIG. 1, the audio signal selection unit 106 selectively outputs, on the basis of the recognition result of the sound direction recognition unit 103, the unidirectional audio signal of the front direction or the unidirectional audio signal of the back direction. This makes it possible to accurately perform the selection while saving time and effort for user operation, for example, operation by an interviewer.

### 2. Modification

Note that in the above-described embodiment, the sound direction recognition unit 103 is configured with, for example, a convolutional neural network, and is configured to recognize, on the basis of the output signal (the audio signal in the frequency domain) by the STFT unit 102, the direction of the sound coming, that is, here, whether the sound comes from the front side or the back side. However, the configuration of the sound direction recognition unit 103 is not limited thereto, and another configuration may be adopted. For example, a configuration is also conceivable in which the levels of sound coming from the front side and sound coming from the back side are detected to recognize, on the basis of the result, the direction of the sound coming.

In addition, in the above-described embodiment, the smartphone 200 is provided with the two non-directional microphones of the non-directional microphone 202 on the top side and the non-directional microphone 203 on the bottom side. However, the present technique can be similarly applied to a smartphone having one or three or more non-directional microphones. In this case, in the smartphone having three or more non-directional microphones, similarly to the embodiment, the audio signals obtained by collecting sound by the non-directional microphones are mixed (added) to be processed.

In addition, in the above-described embodiment, the smartphone 200 is fixedly positioned horizontally. However, the present technique can be similarly applied to a case in which the smartphone 200 is fixedly positioned vertically for its use. In this case, the learning data for the learning of the deep neural network with which the front unidirectional audio signal conversion unit 104 and the back unidirectional audio signal conversion unit 105 are configured, for the learning of the acoustic feature extraction model (convolutional neural network) used during the learning of the above deep neural network, and for the learning of the convolutional neural network with which the sound direction recognition unit 103 is configured can be obtained by making the smartphone 200 fixedly positioned vertically. Note that obtaining the learning data in both the horizontal direction and the vertical direction makes it possible to perform learning capable of handling in both cases where the smartphone 200 is fixedly positioned horizontally and vertically for its use.

In addition, in the above-described embodiment, an example in which the electronic device including the image capturing function is the smartphone 200 has been described. However, the present technique can be similarly applied to a case where the electronic device including the image capturing function is another electronic device, for example, a video camera or the like. In addition, it is also assumed that the electronic device including the audio signal processing apparatus according to the present technique is an electronic device that does not include the image capturing function.

In addition, the preferred embodiment of the present disclosure has been described above in detail with reference to the accompanying drawings, but the technical scope of the present disclosure is not limited to such example. It is apparent that a person having ordinary knowledge in the technical field of the present disclosure can devise various changes or modifications within the scope of the technical idea disclosed in the claims, and it will naturally be understood that they also belong to the technical scope of the present disclosure.

In addition, the effects described in the present specification are merely exemplary or illustrative, and not restrictive. That is, the technique according to the present disclosure can exhibit other effects apparent to those skilled in the art from the description of this specification, in addition to the above-described effects or instead of the above-described effects.

In addition, the present technique can also have the following configurations.
(1) An audio signal processing apparatus including an audio signal conversion unit that converts an audio signal obtained by collecting sound by a non-directional microphone into a unidirectional audio signal.
(2) The audio signal processing apparatus according to the above-described (1), in which
the audio signal conversion unit is configured with a deep neural network.
(3) The audio signal processing apparatus according to the above-described (2), in which
the deep neural network is trained to learn to minimize a difference between an acoustic feature amount extracted from an audio signal converted by the deep neural network and an acoustic feature amount extracted from a unidirectional audio signal obtained by collecting sound by a unidirectional microphone.

(4) The audio signal processing apparatus according to the above-described (3), in which
the acoustic feature amount is extracted as information of a layer of a convolutional neural network.

(5) The audio signal processing apparatus according to claim 4, in which
the convolutional neural network is trained to learn to be able to distinguish between an audio signal obtained by collecting sound by the non-directional microphone and a unidirectional audio signal obtained by collecting sound by the unidirectional microphone.

(6) The audio signal processing apparatus according to any one of the above-described (1) to (5), in which
the non-directional microphone is a microphone attached to an electronic device including an image capturing function.
(7) The audio signal processing apparatus according to the above-described (6), in which
the electronic device includes a smartphone.
(8) The audio signal processing apparatus according to the above-described (7), in which
the smartphone includes, as the non-directional microphone, a first microphone provided on a top side and a second microphone provided on a bottom side, and
an audio signal conversion unit converts a mixed signal of an audio signal obtained by collecting sound by the first microphone and an audio signal obtained by collecting sound by the second microphone into a unidirectional audio signal.
(9) The audio signal processing apparatus according to any one of the above-described (6) to (8), in which
the audio signal processing apparatus includes, as the audio signal conversion unit, a first audio signal conversion unit that converts an audio signal obtained by collecting sound by the non-directional microphone into a unidirectional audio signal of a front direction, and a second audio signal conversion unit that converts an audio signal obtained by collecting sound by the non-directional microphone into a unidirectional audio signal of a back direction, and
the audio signal processing apparatus further including
an audio signal selection unit that selectively outputs a unidirectional audio signal of a front direction obtained by converting by the first audio signal conversion unit or a unidirectional audio signal of a back direction obtained by converting by the second audio signal conversion unit.
(10) The audio signal processing apparatus according to the above-described (9), further including
a sound direction recognition unit that recognizes whether sound is coming from the front direction or sound is coming from the back direction, in which
the audio signal selection unit outputs a unidirectional audio signal of a front direction obtained by converting by the first audio signal conversion unit when it is recognized that sound is coming from the front direction, and outputs a unidirectional audio signal of a back direction obtained by converting by the second audio signal conversion unit when it is recognized that sound is coming from the back direction.

(11) The audio signal processing apparatus according to the above-described (10), in which
the sound direction recognition unit is configured with a convolutional neural network, and
the sound direction recognition unit receives, as an input, an audio signal obtained by collecting sound by the non-directional microphone and outputs a recognition result.
(12) An audio signal processing method including
a procedure of converting an audio signal obtained by collecting sound by a non-directional microphone into a unidirectional audio signal.
(13) An electronic device including an image capturing function, including
a non-directional microphone, and
an audio signal conversion unit that converts an audio signal obtained by collecting sound by the non-directional microphone into a unidirectional audio signal.

### REFERENCE SIGNS LIST

10 Audio signal processing apparatus
101 Mixing unit
102, 108 STFT unit
103 Sound direction recognition unit
104 Front unidirectional audio signal conversion unit
105 Back unidirectional audio signal conversion unit
106 Audio signal selection unit
107 ISTFT unit
111 Front acoustic feature extraction model
112 Back acoustic feature extraction model
200 Smartphone
201 Display
202, 203 Non-directional microphone
300 Unidirectional microphone
301 Interviewee
302 Interviewer
303 Tripod

1. An audio signal processing apparatus comprising:
an audio signal conversion unit that converts an audio signal obtained by collecting sound by a non-directional microphone into a unidirectional audio signal.

2. The audio signal processing apparatus according to claim 1, wherein
the audio signal conversion unit is configured with a deep neural network.

3. The audio signal processing apparatus according to claim 2, wherein
the deep neural network is trained to learn to minimize a difference between an acoustic feature amount extracted from an audio signal converted by the deep neural network and an acoustic feature amount extracted from a unidirectional audio signal obtained by collecting sound by a unidirectional microphone.

4. The audio signal processing apparatus according to claim 3, wherein
the acoustic feature amount is extracted as information of a layer of a convolutional neural network.

5. The audio signal processing apparatus according to claim 4, wherein
the convolutional neural network is trained to learn to be able to distinguish between an audio signal obtained by collecting sound by the non-directional microphone and a unidirectional audio signal obtained by collecting sound by the unidirectional microphone.

6. The audio signal processing apparatus according to claim 1, wherein
the non-directional microphone is a microphone attached to an electronic device including an image capturing function.

7. The audio signal processing apparatus according to claim 6, wherein
the electronic device includes a smartphone.

8. The audio signal processing apparatus according to claim 7, wherein
the smartphone includes, as the non-directional microphone, a first microphone provided on a top side and a second microphone provided on a bottom side, and
an audio signal conversion unit converts a mixed signal of an audio signal obtained by collecting sound by the first microphone and an audio signal obtained by collecting sound by the second microphone into a unidirectional audio signal.

9. The audio signal processing apparatus according to claim 6, wherein
the audio signal processing apparatus includes, as the audio signal conversion unit, a first audio signal conversion unit that converts an audio signal obtained by collecting sound by the non-directional microphone into a unidirectional audio signal of a front direction, and a second audio signal conversion unit that converts an audio signal obtained by collecting sound by the non-directional microphone into a unidirectional audio signal of a back direction, and
the audio signal processing apparatus further comprising:
an audio signal selection unit that selectively outputs a unidirectional audio signal of a front direction obtained by converting by the first audio signal conversion unit or a unidirectional audio signal of a back direction obtained by converting by the second audio signal conversion unit.

10. The audio signal processing apparatus according to claim 9, further comprising:
a sound direction recognition unit that recognizes whether sound is coming from the front direction or sound is coming from the back direction, wherein
the audio signal selection unit outputs a unidirectional audio signal of a front direction obtained by converting by the first audio signal conversion unit when it is recognized that sound is coming from the front direction, and outputs a unidirectional audio signal of a back direction obtained by converting by the second audio signal conversion unit when it is recognized that sound is coming from the back direction.

11. The audio signal processing apparatus according to claim 10, wherein
the sound direction recognition unit is configured with a convolutional neural network, and
the sound direction recognition unit receives, as an input, an audio signal obtained by collecting sound by the non-directional microphone and outputs a recognition result.

12. An audio signal processing method comprising:
a procedure of converting an audio signal obtained by collecting sound by a non-directional microphone into a unidirectional audio signal.

13. An electronic device including an image capturing function, comprising:
a non-directional microphone; and
an audio signal conversion unit that converts an audio signal obtained by collecting sound by the non-directional microphone into a unidirectional audio signal.
